(19) United States
(12) Patent Application Publication
(10) Pub. No.: US 2003/0165332 A1
(43) Pub. Date: Sep. 4, 2003

(54) Constant speed control circuit for a fan

(76) Inventor: Hsin-Mao Hsieh, Pingtung Hsien (TW)

Correspondence Address: BACON & THOMAS, PLLC, 625 SLATERS LANE, FOURTH FLOOR, ALEXANDRIA, VA, 22314

(21) Appl. No.: 10/347,432

(22) Filed: Jan. 21, 2003

Related U.S. Application Data
(63) Continuation-in-part of application No. 09/796,625, filed on Mar. 2, 2001, now abandoned.

(51) Int. Cl. H02P 5/00

(52) U.S. Cl. 388/800

(57) ABSTRACT

A constant speed control circuit for a fan includes a timing control unit, a driving unit and a fan speed control (FSC) unit. The fan speed control unit receives an external frequency signal from a frequency generator, which represents an expected rotational speed of the fan. Based on the external frequency signal, the FSC unit generates an adjusting signal that is input to the timing control unit. After the timing control unit compares a Hall signal with the adjusting signal, driving signals are generated and provided to control the activation time of transistors of the driving unit. Thereby, the fan is operated at a constant speed status.

### CROSS REFERENCE

This is a continuation-in-part of the corresponding U.S. patent application Ser. No. 09/796,625, entitiled “Constant Speed Control Circuit for a Fan”, filed on Mar. 2, 2001.

### BACKGROUND OF THE INVENTION

1. Field of the Invention

The present invention relates to a constant speed control circuit for a fan, and more particularly to a control circuit incorporated with the pulse width modulation (PWM) technique for maintaining the fan to be operated at a constant speed.

2. Description of Related Art

Heat sinks fitted to microprocessors usually have an electric fan as a critical component to achieve optimum heat dissipation from the microprocessor. Thus, reliable performance of the fan is essential to the heat dissipation process, and ultimately performance of the microprocessor. The performance of the fan not only depends on the fan structure, but also depends on its control circuit. A common problem of such a fan is that rotational speed of the fan is not easy to be steadily controlled. Several factors that influence rotational speed are briefly described below.

1. Friction: Friction within a new fan is generally greater than an old fan because the bearings are new in the former and generally produced to be a little tight to allow for some wear during the life of the fan. Thus the different friction causes different rotational speeds during the life of a fan.

2. Temperature: When the temperature surrounding the fan rises, resistance of coils of the fan also increases, thus rotational speed of the fan gradually slows.

Further, in order to fit in different working environments, fans with different rotational speeds are required. Thus manufacturers of fans need to fabricate many different models of fans having different rotational speed specifications, hence the cost is increased due to the need for large stocks of fans.

To overcome the shortcomings, the present invention tends to provide a constant speed control circuit for a fan to mitigate and obviate the aforementioned problems.

### SUMMARY OF THE INVENTION

The main objective of the invention tends to provide a constant speed control circuit that adopts the PWM control technique to control the fan to be operated at a stable rotation speed.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a constant speed control circuit in accordance with the present invention;

FIG. 2 is a circuit diagram showing that the constant speed control circuit of FIG. 1 is applied for controlling a pair of coils of a fan in accordance with the present invention; and

FIG. 3 is a circuit diagram showing that the constant speed control circuit of FIG. 1 is applied for controlling a single coil of a fan in accordance with the present invention.

### DETAILED DESCRIPTION OF THE PREFERRED EMBODIMENT

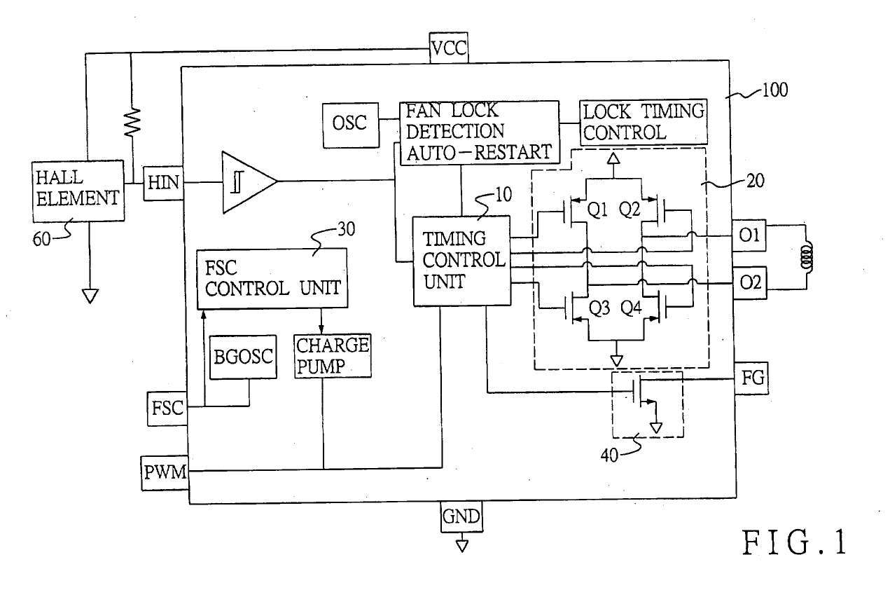

With reference to FIG. 1, a constant speed control circuit (100) in accordance with present invention mainly comprises a timing control unit (10), a driving unit (20) and an FSC (fan speed control) control unit (30). The driving unit (20) is composed of four transistors (Q1-Q4) each connected to respective output terminals of the timing control unit (10). The node that the second and fourth transistors (Q2 and Q4) connect together is further employed as a first output terminal (O1), similarly, the node that the first and third transistors (Q1 and Q3) connect together acts as a second output terminal (O2). The two output terminals (O1 and O2) are able to connect to a pair of coils or a single coil of the fan.

The timing control unit (10) further has an output terminal connected to a signal generating unit (40). The output signal from the FSC control unit (30), which is in the form of pulse width modulation (PWM), is input to the timing control unit (10).

The timing control unit (10) receives a “Hall signal” (HIN) from a Hall element (60) that detects the polarity variation of a fan for obtaining the immediate rotational speed of the fan (not shown). The activation of the transistors (Q1-Q4) in the driving unit (20) is determined by the timing control unit (10). By properly controlling the four transistors (Q1-Q4), a driving current can flow through the coil and drive the fan to rotate.

The FSC control unit (30) receives an external reference signal from a terminal, wherein the external reference signal represents a preset desired rotation speed for the fan. Once the fan exceeds or gets behind the preset rotation speed, the timing control unit (10) is able to detect such a situation based on the Hall signal.

The FSC control unit (30) generates an adjusting signal that is in the form of a PWM signal based on the external reference signal, i.e. the preset rotation speed. Such a PWM signal is then input into the timing control unit (10). The timing control unit (10) compares the PWM signal with the Hall signal to obtain a driving signal that determines the activation period of the four transistors (Q1-Q4). As mentioned above, since the external frequency signal (FSC) represents an expected rotational speed of the fan, by comparing the Hall signal and the external frequency signal (FSC), the speed of the fan is gradually adjusted to achieve the expected rotational speed. As an example, when the fan exceeds the preset rotation speed, the speed is able to be slowed down by reducing the activation period of the transistors.

In the present invention, the external reference signal is provided by a frequency signal generator. The expected rotation speed for the fan is able to be set by adjusting the frequency signal generator, wherein the frequency signal generator is an oscillator, such as a crystal oscillator, a ceramics oscillator, a surface audio wave (SAW) oscillator or an oscillator composed of a resistor and a capacitor.

The signal generating unit (40), which is composed of a transistor, generates clock signals. The clock signals represent the rotation speed of the fan and are able to be detected by other components that need to obtain the operation situation of a fan, such as a microprocessor (not shown).

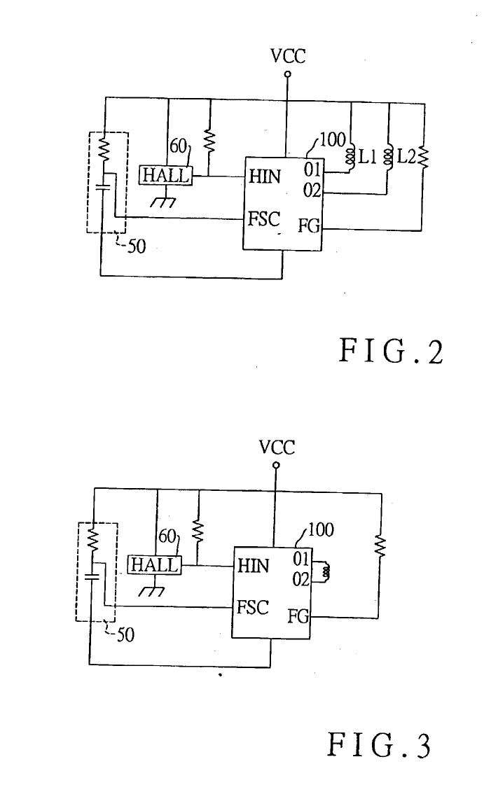

With reference to FIG. 2, the constant speed control circuit (100) is applied to control a pair of coils (L1 and L2) of the fan, wherein the output terminals (O1 and O2) are respectively connected to coils (L1 and L2). The coils (L1 and L2) are further connected to a power supply (VCC). In FIG. 2, the frequency signal generator is composed of a resistor and a capacitor. By changing a resistance value or capacitance value, the expected rotational speed is easily achieved.

With reference to FIG. 3, the constant speed control circuit (100) is applied to control a single coil (L), wherein both the output terminals (O1 and O2) are connected to the coil (L), and the frequency signal generator is composed of a resistor and a capacitor.

According to the above description, the present invention has the following advantages:

1. The rotational speed is easily controlled by setting an expected external frequency signal, and when the external frequency signal is set at a fixed value, the rotational speed of the fan is retained at a constant speed.

2. The rotational speed of the fan does not vary due to changes in temperature and friction of bearings.

3. Manufacturers do not need to fabricate different models of fan having different specifications (rotational speed) to match different working environments.

4. The constant speed control circuit is fabricated as an integrated circuit, hence the volume of the circuit is small.

Although the present invention has been explained in relation to its preferred embodiment, it is to be understood that many other possible modifications and variations can be made without departing from the spirit and scope of the invention as hereinafter claimed.

What is claimed is:

1. A constant speed control circuit for a fan comprising:
a timing control unit receiving a Hall signal from a Hall element that is used for detecting a rotational speed of the fan;
a driving unit connected to the timing control unit and driving the fan to rotate;
a fan speed control unit connected to the timing control unit and receiving an external reference signal, wherein an adjusting signal in the form of a pulse width modulation (PWM) signal is generated based on the external reference signal, and then the PWM signal is input to the timing control unit;
wherein the timing control unit compares the Hall signal with the adjusting signal to generate a driving signal for the driving circuit thereby controlling the fan to be operated at a constant speed.

2. The constant speed control circuit for a fan as claimed in claim 1, wherein the driving unit is composed of four transistors.

3. The constant speed control circuit for a fan as claimed in claim 1, wherein the frequency signal generator is composed of a resistor and a capacitor.

4. The constant speed control circuit for a fan as claimed in claim 1, wherein the frequency signal generator is an oscillator.

5. The constant speed control circuit for a fan as claimed in claim 4, wherein the oscillator is a crystal oscillator.

6. The constant speed control circuit for a fan as claimed in claim 4, wherein the oscillator is a ceramics oscillator.

7. The constant speed control circuit for a fan as claimed in claim 4, wherein the oscillator is a surface audio wave (SAW) oscillator.

8. The constant speed control circuit for a fan as claimed in claim 1, wherein a signal generating unit is connected an output terminal of the timing control unit for generating a clock signal.

9. The constant speed control circuit for a fan as claimed in claim 1 wherein the circuit is an integrated circuit.
